(19) United States
(12) Patent Application Publication
(10) Pub. No.: US 2015/0364933 A1
(43) Pub. Date: Dec. 17, 2015

(54) EMERGENCY BATTERY ACTIVATING ASSEMBLY AND EMERGENCY BATTERY ACTIVATING METHOD

(71) Applicant: YI-FAN CHANG, New Taipei City (TW)

(72) Inventor: YI-FAN CHANG, New Taipei City (TW)

(21) Appl. No.: 14/301,939

(22) Filed: Jun. 11, 2014

(51) Int. Cl. H02J 7/00; B60L 11/18

(52) U.S. Cl. CPC H02J 7/007; H02J 7/0052; B60L 11/1809

(57) ABSTRACT

The present invention relates to an emergency battery activating assembly applied to car or motorcycle batteries, including at least a preset power supply device, a preset battery, and an activating device. The battery includes at least a conductive portion with a detect voltage value. The activating device is electrically connected to the power supply device and includes an input end, a reference voltage value, and a comparison unit. The input end is electrically connected to the conductive portion. The reference voltage value is set at below 0.5V. The comparison unit is electrically connected to the input end and is used to compare the detect voltage value and the reference voltage value. When the input end is electrically connected to the conductive portion, if the detect voltage value is larger than the reference voltage value, the activating device would activate the power supply device and provide power to the battery. Further, the present invention also relates to an emergence battery activating method.

### BACKGROUND OF THE INVENTION

1. Field of the Invention

The present invention relates to an emergency battery activating assembly and an emergency battery activating method. particularly to an emergency battery activating assembly and an emergency battery activating method which can activate a battery with excessively low remaining voltage.

2. Description of Related Art

Vehicles such as cars or motorcycles are usually equipped with a battery to provide electric power. When a user is driving a car or a motorcycle, the operating engine of the car or the motorcycle would charge the battery. When the car or the motorcycle consumes electricity, for example to start the motor, the headlight, the car stereo system, the air conditioner, etc, electric power is supplied by the battery.

If a driver forgets to turn off the headlight, the night light, or any other electric device on a vehicle which consumes electricity before leaving the vehicle, the electric power of the battery may be exhausted and the vehicle may be unable to start because the battery continues to provide electricity without being charged. When this happens, a driver may activate the vehicle with the help of another vehicle's battery. This, however, requires a power line to connect the two batteries. Furthermore, the power line needs to be connected to the correct electrodes of the two batteries; otherwise there may be risk of short circuit.

Emergency vehicle rescue device has been invented, which includes an electric circuit for automatically detecting the electrode of a vehicle battery. When a vehicle battery is over-discharged and cannot be started, the emergency vehicle rescue device may be used to electrically connect the two conductive terminals of the battery and provide enough power for the vehicle to start.

However, the above-mentioned emergency vehicle rescue device has the following problems and disadvantages:

The above-mentioned emergency vehicle rescue device relies on the remaining power of a vehicle battery to detect the electrode of the battery. If a user leaves a vehicle headlight on for a long period of time, the remaining voltage of the vehicle battery may be almost completely exhausted. In this case, the above-mentioned emergency vehicle rescue device would not be able to detect the electrode of the vehicle battery and provide power to it.

Further, the above-mentioned emergency vehicle rescue device generally detects the remaining voltage of a battery by means of such a component as a transistor or an optical coupler. The breakover voltage of a transistor is 0.7V, and the operating voltage of an optical coupler is 2V. In addition, when detecting the remaining voltage of a battery, the emergency vehicle rescue device requires not only a certain voltage value but also a certain current value. For example, an optical coupler requires a current value of at least 10 mA to drive and activate the vehicle battery. Therefore, if a vehicle headlight is left on for a long period of time and the power of the vehicle battery is exhausted, the remaining voltage of the battery would be below 0.7V and would not be activated.

In view of this, to address the above-mentioned problems and disadvantages, after laborious research and experiments, the applicant has devised the emergency battery activating device of the present invention.

### SUMMARY OF THE INVENTION

It is an object of the present invention to provide an emergency battery activating assembly and an emergency battery activating method which can activate a battery with excessively low remaining voltage.

To achieve the foregoing object, the emergency battery activating assembly of the present invention is applied to car or motorcycle batteries and includes at least a preset power supply device, a preset battery, and an activating device. The battery includes at least a conductive portion with a detect voltage value. The activating device is electrically connected to the power supply device and includes an input end, a reference voltage value, and a comparison unit. The input end is electrically connected to the conductive portion. The reference voltage value is set at below 0.5V. The comparison unit is electrically connected to the input end and is used to compare the detect voltage value and the reference voltage value. When the input end is electrically connected to the conductive portion, if the detect voltage value is larger than the reference voltage value, the activating device would activate the power supply device and provide power to the battery.

In a preferred embodiment, the present invention further includes a connecting line, whereon the activating device is disposed.

In a preferred embodiment of the present invention, the comparison unit is a comparator.

Further, the present invention also relates to an emergence battery activating method applied to car and motorcycle batteries, including at least the following steps: an activating device with a reference voltage value set at below 0.5V is connected to a battery with a detect voltage value; the activating device compares the detect voltage value and the reference voltage value; and the activating device would activate the power supply device and provide power to the battery if the detect voltage value is larger than the reference voltage value.

The present invention includes a comparison unit to compare the detect voltage value and the reference voltage value. If the detect voltage value is larger than the reference voltage value, the activating device would activate the power supply device and provide power to the battery. Because a comparator can perform comparison with only a voltage difference of 1 mV between the in-phase input end and the anti-phase input end and a small current (around 1 mA), the present invention can activate a battery with excessively low remaining voltage (below 0.5V), for example 0.05V, and is highly compatible.

### BRIEF DESCRIPTION OF THE INVENTION

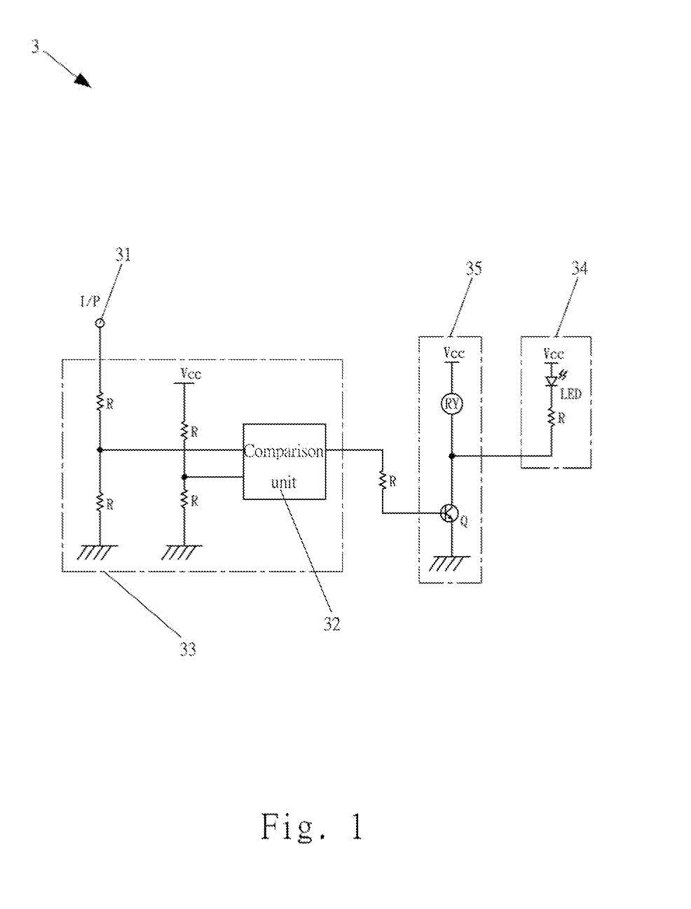

FIG. 1 is a circuit diagram of a preferred embodiment of the present invention;

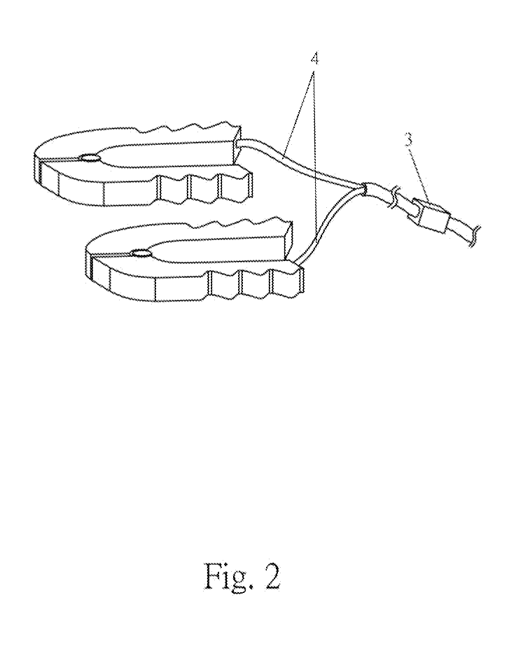

FIG. 2 is a first schematic drawing of an implementation of a preferred embodiment of the present invention;

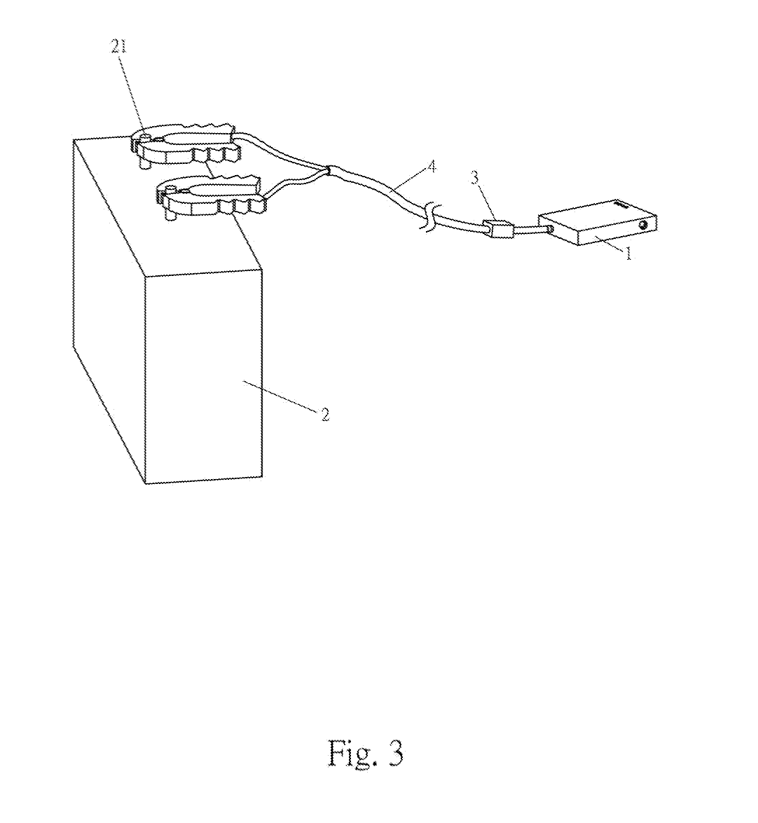

FIG. 3 is a second schematic drawing of an implementation of a preferred embodiment of the present invention;

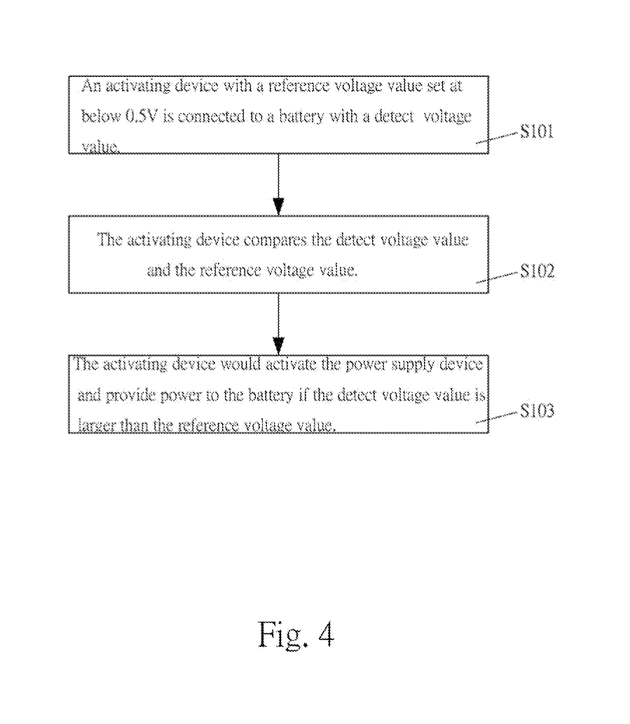

FIG. 4 is a flow chart of a preferred embodiment of the present invention.

### DETAILED DESCRIPTION OF THE PREFERRED EMBODIMENT

To achieve the above-mentioned objects and effects. the techniques, measures, and structure of the present invention is illustrated in the figures and descriptions of preferred embodiments below.

Please refer to FIGS. 1. 2, and 3, showing respectively a circuit diagram of a preferred embodiment of the present invention, a first schematic drawing and a second schematic drawing of an implementation of a preferred embodiment. As the figures show, the emergency battery activating device of the present invention is applied to car and motorcycle batteries, wherein the car is an internal combustion vehicle. The battery in the preferred embodiment is a lead-acid battery, but the present invention does not limit the kind of battery; a lithium-iron battery may also be used, for example. The emergency battery activating assembly of the present invention includes at least a preset power supply device 1, a preset battery 2, and an activating device 3.

The output setting of the power supply device 1 corresponds to the 12V of battery 2. Preferably, the power supply device may be, but not limited to, a battery, an AC/DC power supply device, or a super capacitor.

The battery 2 includes at least a conductive portion 21 with a detect voltage value, which is the remaining voltage of the battery 2. The activating device 3 is electrically connected to the power supply device 1 and includes an input end 31, a reference voltage value, and a comparison unit 32. The input end 31 is electrically connected to the conductive portion 21. The reference voltage value is set at below 0.5V. In practice, the reference voltage value may be set below 0.4V, 0.3V, 0.2V, 0.1V, or 0.05V according to actual conditions. The comparison unit 32 is electrically connected to the input end 31 and is used to compare the detect voltage value and the reference voltage value. When the input end 31 is electrically connected to the conductive portion 21, if the detect voltage value is larger than the reference voltage value, the activating device 3 would activate the power supply device 1 and provide power to the battery 2. FIG. 1 is circuit diagram of the activating device 3 in actual use, wherein R represents resistance, Q represents transistor, RY represents relay, LED represents light emitting diode, and Vcc represents power source.

As FIG. 2 shows, preferably. the present invention further includes a connecting line 4. whereon the activating device 3 is disposed. And as FIG. 3 shows, the present invention is applied to a car or motorcycle battery 2 and can activate a battery 2 with excessively low remaining voltage.

The practical operation of the present invention is described below.

The present invention includes a comparison unit 32. In the present preferred embodiment, the comparison unit is a comparator. When the input end 31 is electrically connected to the conductive portion 21, the comparison unit 32 compares the detect voltage value and the reference voltage value. If the detect voltage value is larger than the reference voltage value, the activating device 3 would activate the power supply device 1 and provide power to the battery 2.

Further, a comparator is an electronic component which compares the magnitude of two input voltages or currents and output the result of the comparison. The comparator may also be a built-in comparator in a microprocessor. In practice, an excessively low reference voltage value may be set for the component, for example 0.05V. Therefore, when the input end 31 of the activating device 3 is electrically connected to the conductive portion 21, the activated circuit receives the detect voltage value of the battery 2 via the input end 31 and compares the detect voltage value and the reference voltage value via the comparison unit 32. For example, if the reference voltage value is set at 0.05V and the detect voltage value is 0.3V, the present invention can activate the battery 2 because the detect voltage value is larger than the reference voltage value. Therefore, the present invention can activate a battery 2 with excessively low remaining voltage (below 0.5V), for example 0.05V, and is highly compatible.

In FIG. 1, the present invention includes a comparison circuit 33, a display circuit 34, and activating circuit 35. The comparison circuit 33 is used to compare the detect voltage value and the reference voltage value. The display circuit 34 indicates whether the activating device 3 of the present invention is in operation via LED according to a signal from the input end 31. The activating circuit 35 determines whether to activate the power supply device 1 and provide power to the battery 2 according to the output of the comparison circuit 33.

Please refer also to FIG. 4, showing a flow chart of a preferred embodiment of the present invention. As the figure shows, the present invention also relates to an emergent battery rescue method applied to car or motorcycle batteries 2, including at least the following steps: S101 an activating device 3 with a reference voltage value set at below 0.5V is connected to a battery 2 with a detect voltage value; S102 the activating device 3 compares the detect voltage value and the reference voltage value; and S103 the activating device 3 would activate a power supply device 1 and provide power to the battery 2 if the detect voltage value is larger than the reference voltage value.

In comparison with conventional techniques, the present invention has the following advantages: it can activate a battery 2 with excessively low remaining voltage (below 0.5V), for example 0.05V, and is highly compatible.

The fore-going preferred embodiments of the present invention are illustrated of the present invention rather than limiting of the present invention. It is intended to cover various modifications and changes included within the spirit and scope of the appended claims, the scope of which should be accorded the broadest interpretation so as to encompass all such modifications and similar structures.

What is claimed is:

1. An emergency battery activating assembly applied to car or motorcycle batteries, comprising at least,
a preset power supply device;
a preset battery, including at least a conductive portion with a detect voltage value; and
an activating device, electrically connected to the power supply device, including an input end, a reference voltage value, and a comparison unit; the input end is electrically connected to the conductive portion; the reference voltage value is set at below 0.5V; the comparison unit is electrically connected to the input end and is used to compare the detect voltage value and the reference voltage value; when the input end is electrically connected to the conductive portion, if the detect voltage value is larger than the reference voltage value, the activating device would activate the power supply device and provide power to the battery.

2. The emergency battery activating assembly of claim 1. wherein a connecting line is further included whereon the activating device is disposed.

3. An emergence battery activating method applied to car and motorcycle batteries, including at least the following steps:
an activating device with a reference voltage value set at below 0.5V is connected to a battery with a detect voltage value;
the activating device compares the detect voltage value and the reference voltage value; and
the activating device would activate the power supply device and provide power to the battery if the detect voltage value is larger than the reference voltage value
